(19) United States
(12) Patent Application Publication
(10) Pub. No.: US 2009/0153736 A1
(43) Pub. Date: Jun. 18, 2009

(54) EMBEDDED VIDEO DEMO MODE FOR TELEVISION

(76) Inventor: Peter Mortensen, Tustin, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/958,246

(22) Filed: Dec. 17, 2007

(51) Int. Cl. H04N 5/50

(52) U.S. Cl. 348/569; 348/E05.097

(57) ABSTRACT

Process and methods for effectively displaying product features in a point of purchase environment to draw the attention of the consumer to the manufacturer's television. In one embodiment, the un-used capacity of the television memory devices are used to store and run an embedded video demo. The embedded video demo can be accessed through the television's menu structure, via a dedicated button on the remote control device, or can be set to run periodically after a predetermine time period. When the embedded video is set to play continuously or periodically, the television's on-screen-display controller blocks the display on the screen of a primary video corresponding to a program signal being input to the television, which in many instances will be a common program signal broadcast to all of the televisions on display in a consumer electronics store or department.

### FIELD

The present invention relates generally to televisions and, more particularly, to systems and methods that facilitate the utilization of an embedded video mode in a point of purchase environment.

### BACKGROUND

Television sales continue to become more and more competitive as the capabilities and the features of televisions continue to expand and improve. Televisions, like most other consumer electronic products, are typically sold in a consumer electronics store or a consumer electronics department of a large department store. As depicted in FIG. 1, a typical television display 5 in the consumer electronics store or consumer electronics department has a series of televisions 10 from multiple manufactures positioned side by side on one or more display shelves 7. Alternatively, as depicted in FIG. 2, higher end televisions 10 may be displayed in close proximity with one another in home theater arrangements 20 with sound systems comprising front, center and sub-woofer speakers 22, 24 and 26. In each instance, the consumer C typically sees the same program being displayed on each of the televisions as the same program signal is broadcast to each of the televisions. As a result, it is difficult for the consumer C to distinguish one manufacturer's television from another. Because the consumer C typically won't wait for more than a few seconds when judging picture quality, playing a long video tends only to give a consumer a somewhat random impression of the picture performance.

Therefore, it would be desirable to provide systems and methods that facilitate an effective display of product features in a point of purchase environment.

### SUMMARY

Embodiments described herein are directed to improved methods, systems and apparatus for effectively displaying product features in a point of purchase environment to draw the attention of the consumer to the manufacturer's television. In a preferred embodiment, the un-used capacity of the television flash memory devices are used to store and run an embedded video demo. The embedded video demo can be accessed through the television's menu structure, via a dedicated button on the remote control device, or can be set to run periodically after a predetermine time period. When the embedded video is set to play continuously or periodically, the television's on-screen-display (OSD) controller blocks a primary video corresponding to the program signal being input to the television from being displayed on the television's screen. The primary video will in many instances typically correspond to a common program signal broadcast to all of the televisions on display in a consumer electronics store or department.

In one embodiment, the television includes a screen, an OSD controller, a projection or image display system coupled to the screen and the OSD controller, and a CPU coupled to the OSD controller. The CPU preferably includes flash memory devices and an embedded demo video or other content stored in the memory as well as software to decode an embedded demo video and control the display of the embedded video or other content.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a plan view of a conventional television display system in a consumer electronics store or consumer electronics department of a department store.

FIG. 2 is a plan view of a home theater television display system in a consumer electronics store or consumer electronics department of a department store.

FIG. 3 is a graph illustrating the growth in the capacity of the flash memory devices over time relative to the grown in the memory capacity demand for current conventional televisions.

FIG. 4 is a plan view graphically illustrating the allocation of the capacity of a flash memory device in televisions

FIG. 5 is a process flow diagram illustrating the components of an embedded video.

FIG. 6a-6c are process flow diagrams illustrating components of alternative embedded videos.

FIG. 7 is a schematic of a television control and projection system.

FIG. 8 is a process flow diagram illustrating a menu system used for activation of the embedded demo video.

FIG. 9 is a process flow diagram illustrating the operation of the embedded demo video.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

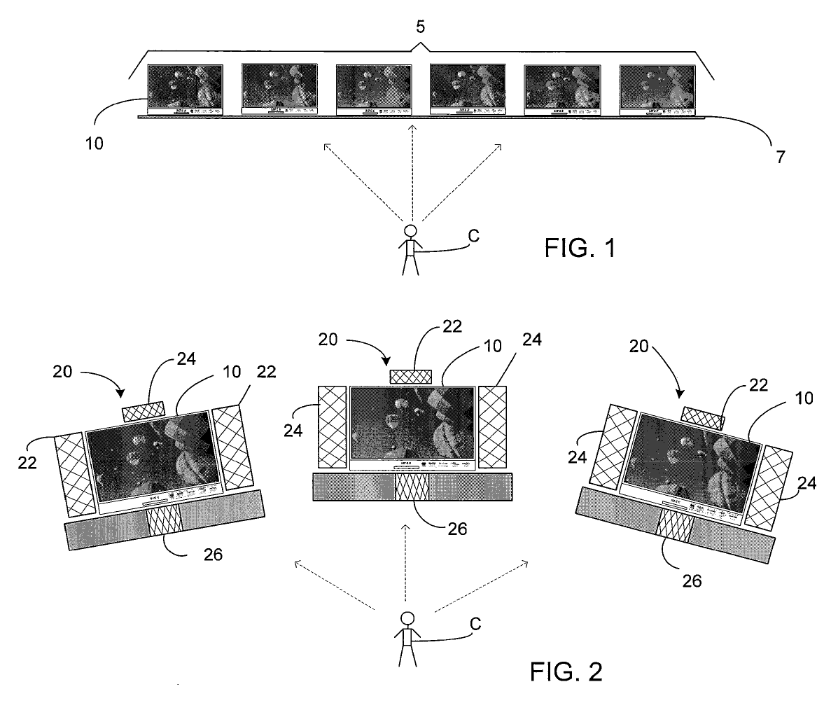

Embodiments described herein are directed to improved methods, systems and apparatus for effectively displaying product features in a point-of-purchase (POP) environment to draw the attention of the consumer to the manufacturer's television and its features. As depicted in FIG. 1, a television display 5 found in a conventional consumer electronics store or in a consumer electronics department of a large department store, typical has televisions 10 from multiple manufactures positioned side by side one or more display shelves 7. Alternatively, as depicted in FIG. 2, higher end televisions 10 may be displayed in close proximity with one another in home theater arrangements 20 with sound systems comprising front, rear (not shown), center and sub-woofer speakers 22, 24 and 26. In each instance, the consumer C typically sees the same program being displayed on each of the televisions as the same program signal is broadcast to each of the televisions by the store or department. As a result, it is difficult for the consumer C to distinguish one manufacturer's television from another in a typical point-of-purchase environments.

Many manufacturers have resorted to playing an extended demo video in an attempt to highlight the picture quality features of their television. However, the consumer C typically only waits a few seconds when judging picture quality, thus playing a long video tends only to give a consumer C a somewhat random impression of the picture performance. Instead of a long video that only gives the consumer C a somewhat random impression of picture performance, embodiments provided herein are directed to the use of short video clips, on the order of 10 to fifty seconds, and more preferably, 10 to 20 or 30 seconds, as part of a demo sequence.

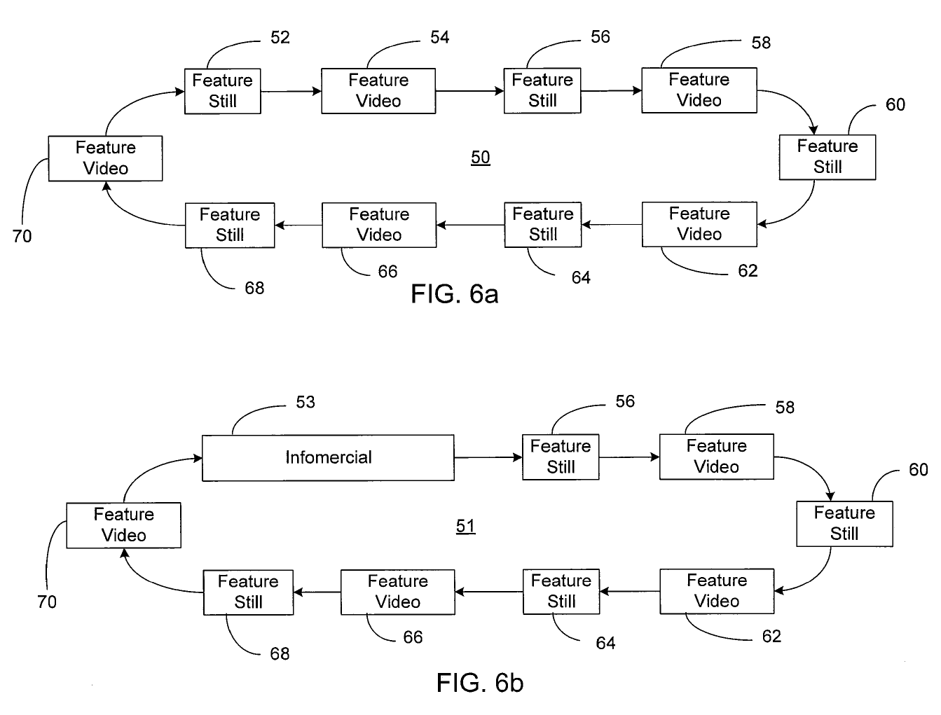

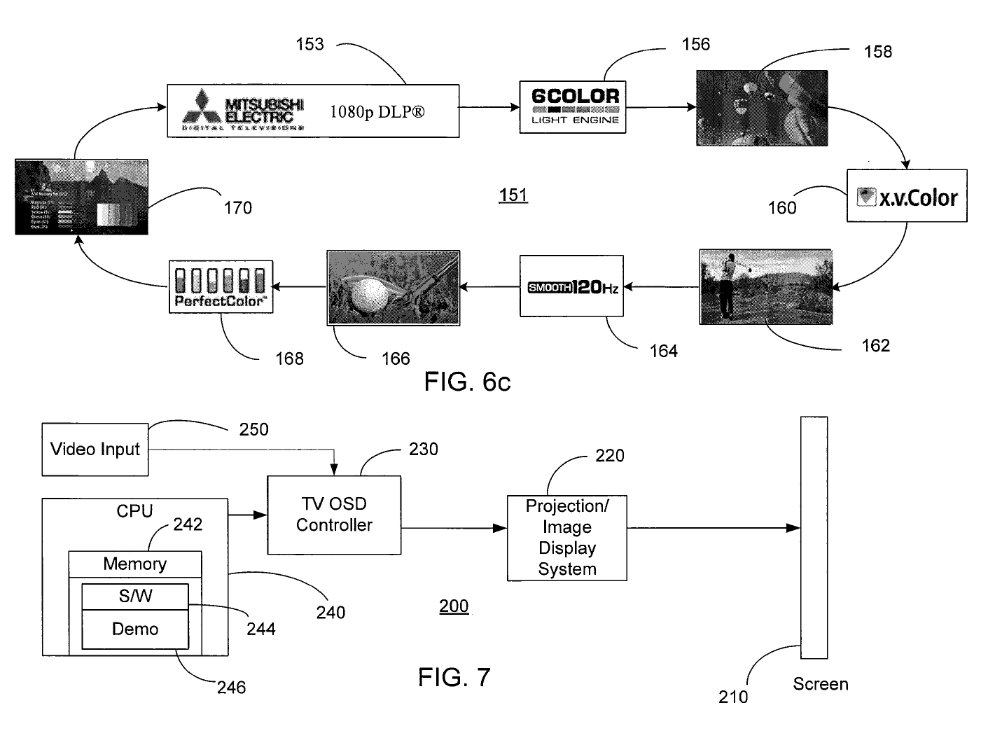

As depicted in FIG. 5, the demo video sequence 40 could comprise a high definition video clip 42 such as a video clip in flash, MPEG-4 HDTV, or other available formats, a high definition photo slide show 44, and an infomercial video clip 46 detailing the market positioning features of the manufacturer's television. Alternatively, as depicted in FIG. 6a, the demo video sequence 50 could comprise series of photo or image stills 52, 56, 60, 64 and 68 corresponding to the market positioning features of the manufacturer's television, such as, e.g., 6 color, 1080p, smooth 120 hz and the like, and interposed by a series of short video clip 54, 58, 62, 66 and 70 comprising a demonstration of the feature highlighted in the preceding still 52, 56, 60, 64 or 68. In a further alternative embodiment, the demo video sequence 51 could comprise, as depicted in FIG. 6b, an infomercial video clip 53 about the manufacturer, the television, the television type and the like, followed by a series of photo or image stills 56, 60, 64 and 68 corresponding to the market positioning features that are interposed by a series of short video clips 58, 62, 66 and 70 comprising a demonstration of the feature highlighted in the preceding still 56, 60, 64 or 68. Other alternatives may include a slide show or a series of stills accompanied by an audio track or stills with videos playing in inset windows.

An example of a preferred video sequence 151 is provided in FIG. 6c. As depicted, the video sequence comprises an infomercial video clip 153 of Mitsubihi's 1080p DLP® television, followed by a series of feature stills 156, 160, 164 and 168 and corresponding feature videos 158, 162, 166, and 170 demonstrating the feature highlighted in the preceding still. For example, a first still 156 highlights the television's 6 color light engine and is followed by a video clip 158 of multicolor balloons demonstrating this feature. The second, third and fourth stills 160, 164 and 168 highlight the television's x.v. color, smooth 120 Hz and perfect color features, respectively, and are followed by video clips of golf and scenic lake videos to highlight these features.

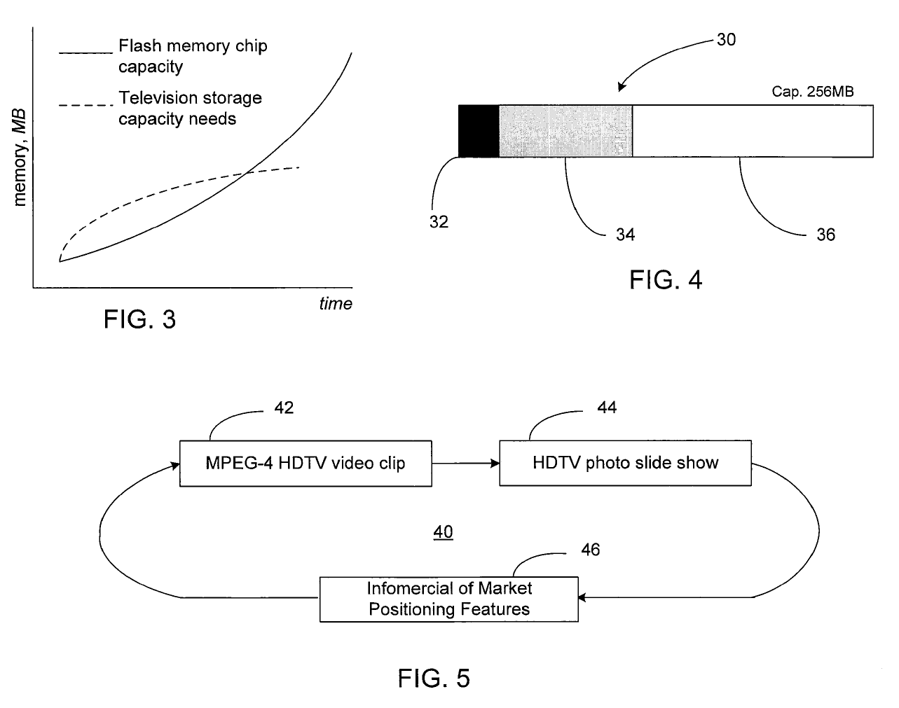

Instead of requiring these video sequences to be played from a peripheral device, e.g., an internal or external DVD, which would require the cooperation of the store's or department's personnel, the video clip or sequence is advantageously embedded in memory within the television system, stored preferably in the excess capacity of the television's flash memory devices. As shown in FIG. 3, the capacity of flash memory components has been and continues to increase faster than what is needed for a typical television application. The rapid increase in capacity is due to pressure from other applications, e.g., cell phones, MP3s, PDAs, camera, and the like, using flash components for media storage. Because of this, the flash memory components television manufacturers are forced to use have excess capacity. As depicted in FIG. 4, the flash memory device 30, which, as shown for exemplary purposes only, has a capacity of 256 MB, the amount of capacity 32 reserved for file management systems, such as a FAT, and the capacity 34 needed for the operation of the television is significantly less than the total capacity of the memory device 30. The excess capacity 36, which can be substantial, would preferably be used to store and control an embedded video sequence.

Turning to FIG. 7, a control and image display system 200 of a television preferably includes a screen 210, a projection/image display system 220 coupled to the screen 210, an on-screen-display (OSD) controller 230 coupled to the display system 220, a video input 250 coupled to the OSD controller 230, and a central processing unit (CPU) 240 coupled to the OSD controller 230. The CPU 240 preferably includes non-volatile memory 242 in the form of flash memory chip upon which the embedded video clip or sequence 246 is stored along with software 244 which includes a set of instructions for decoding the embedded video, and for activating or deactivating the embedded video 246, and instructing the OSD controller 230 to display the embedded video 246 on the screen 210 of the television and block the display on the screen 210 of any video being input to the video input 250.

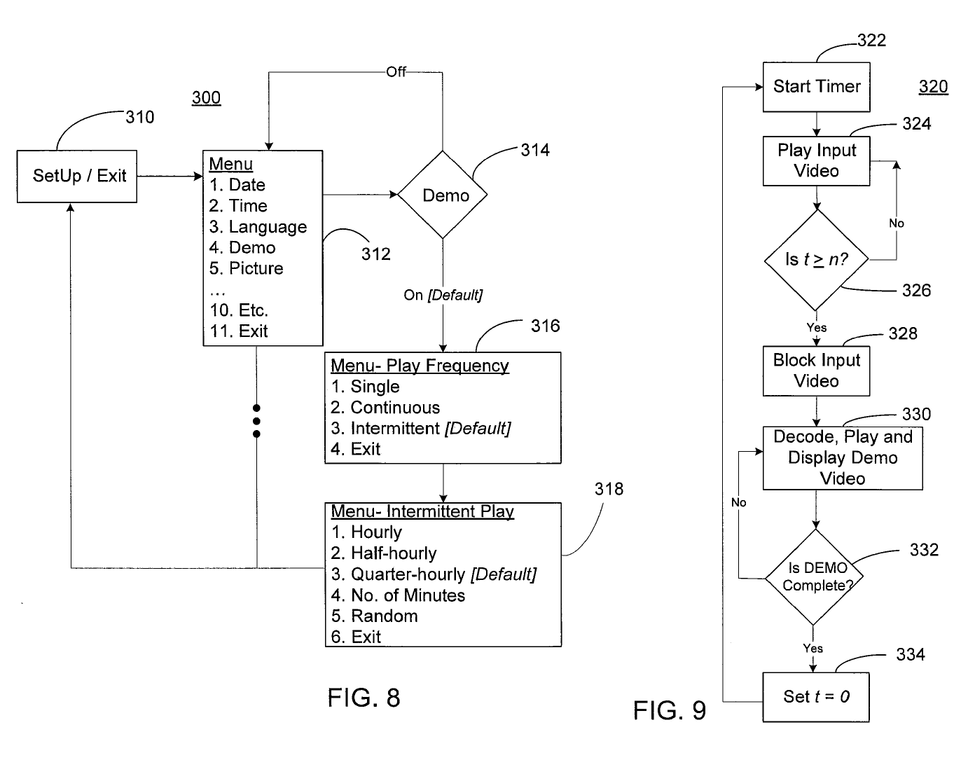

As depicted in FIG. 8, the embedded video function can be operated through the television's menu structure 300 through the television's on-screen user interface. If an operator selects the “setup” feature when the menu 310 is displayed, a “setup” menu 312 is displayed on the screen. If the operator selects the “demo” feature in the “setup” menu 312, the operator is presented with a decision 314 of turning the “demo” mode “On” or “Off”. If the operator chooses to turn the demo mode on, which, as shown, can be the default setting when the television leaves the manufacturer's factory, a “play frequency” menu 316 is preferably displayed from which the operator can select the frequency by which the embedded video is played, which, e.g., includes the option of being played a single time, continuously, or intermittently, or leave the setting on the default, which is depicted as intermittent, and exit. If the operator chooses to play the embedded video intermittently, which, as shown, can be the default setting when the television leaves the manufacturer's factory, an “Intermittent Play” menu 318 is displayed from which the operator can select periods of time between each play of the video, such as, e.g., hourly, half-hourly, quater-hourly, some specified number of minutes, or random, or leave the setting on the default, which is depicted as “quarter-hourly”, and exit.

Should the operator choose at decision block 314 to deactivate/turn off the demo or not play the embedded video, the operator is returned to the setup menu 312.

In operation, as depicted in FIG. 9, the intermittent play process 320 comprises starting a timer at step 322 and then playing a program video inputted to the television through the video input (250 in FIG. 7) at step 324. If, at step 326, the time t is not greater than or equal to a predetermined time period, n, e.g., a quarter hour, the process continues playing the input video. If t is greater than or equal to n, then at step 328, the OSD controller is instructed to block the input video and at step 330 the demo video is decoded and played and the OSD controller is instructed to display the embedded video on the screen. At step 332, the system checks to see if the embedded video has completed playing. If yes, t is set equal to zero at step 334 and the timer is restarted at step 322.

Alternatively, in a random intermittent play process, the predetermined period n can be set to a new value at step 334.

The particular examples set forth herein are instructional and should not be interpreted as limitations on the applications to which those of ordinary skill are able to apply this device. Modifications and other uses are available to those skilled in the art which are encompassed within the spirit of the invention as defined by the scope of the following claims.

What is claimed is:

1. A control and image display system for a television comprising
a screen,
a projection/image display system coupled to the screen,
an on-screen-display (OSD) controller coupled to the display system and the screen,
a video input coupled to the OSD, and
a central processing unit (CPU) coupled to the OSD controller, the CPU comprising non-volatile memory upon which content is stored along with a software program, the software program includes a set of instructions for instructing the OSD controller to display the stored content on the screen and block the display of video input through the video input.

2. The system of claim 1 wherein the content is in the form of one or more still images.

3. The system of claim 1 wherein the content is in the form of a video clip.

4. The system of claim 1 wherein the software program further comprises instructions for activating or deactivating the display of the content on the screen.

5. The system of claim 1 wherein the software program further comprises instructions for selecting and controlling a plurality of display modes corresponding to the frequency of display of the content.

6. The system of claim 1 wherein the software program further comprises instructions for controlling the display of the content at predetermined intervals.

7. The system of claim 1 wherein the software program further comprises instructions for controlling the display of the content at random intervals.

8. A process for displaying content on a screen of a television in a point of purchase environment comprising the steps of
blocking the display on a screen of a television of a video program being input into the television from an external source, and
displaying on the screen content embedded in memory in the television.

9. The process of claim 8 wherein the content is in the form of one or more still images.

10. The process of claim 8 wherein the content is in the form of a video clip.

11. The process of claim 8 further comprising the step of activating the display of the content on the screen.

12. The process of claim 11 further comprising the step of deactivating the display of the content on the screen.

13. The process of claim 8 further comprising the step of selecting and controlling a plurality of display modes corresponding to the frequency of display of the content.

14. The process of claim 8 further comprising the step of displaying the content at predetermined intervals.

15. The process of claim 8 further comprising the step of displaying the content at random intervals.
